(19) United States
(12) Patent Application Publication
(10) Pub. No.: US 2022/0395047 A1
(43) Pub. Date: Dec. 15, 2022

(54) SHOE, IN PARTICULAR A BATHING SANDAL

(71) Applicant: Sunies GmbH, Wien (AT)

(72) Inventor: Alessandra Wieser, Wien (AT)

(73) Assignee: Sunies GmbH, Wien (AT)

(21) Appl. No.: 17/771,800

(22) PCT Filed: Oct. 20, 2020
(86) PCT No.: PCT/EP2020/079434

§ 371 Date: Apr. 25, 2022

(30) Foreign Application Priority Data
Oct. 24, 2019 (AT) GM50187/2019

(51) Int. Cl. A43B 3/10; A43B 13/22; A43B 3/12

(52) U.S. Cl. CPC A43B 3/103; A43B 13/223; A43B 3/108; A43B 3/128

(57) ABSTRACT

A shoe is provided that includes a sole with an outsole and toe bridge opening, a tread arranged in the form of a tread pattern on the outsole, a strap which, together with the sole, forms a foot opening for holding the foot in the metatarsal and/or toe area, and a toe bridge. The toe bridge extends from the strap through the foot opening and through the toe bridge opening of the sole. A button is configured to secure the toe bridge to the sole by preventing the toe bridge from being pulled out of the toe bridge opening. The button has a shape that completes the tread pattern. In embodiments, the shoe is a bathing sandal.

### CROSS-REFERENCE TO RELATED APPLICATION(S)

This application is the National Stage of International Patent Application No. PCT/EP2020/079434 filed on Oct. 20, 2020, which claims priority from Austrian Patent Application No. GM50187/2019 filed on Oct. 24, 2019, both of which are herein incorporated by reference in their entireties.

### SUMMARY

The invention relates to a shoe, and in particular a bathing sandal.

Shoes, in particular bathing sandals such as flip-flops, are known in different embodiments. Generally, bathing sandals usually have a sole and an open shoe upper. It is known that bathing sandals only comprise a straight strap that holds the foot in the metatarsal area. Further, so-called flip-flops are known, where obliquely extending straps are connected to the sole via a toe bridge. Additionally, also a heel strap may be provided for holding the heel. If such kinds of shoes are to be used as bathing sandals, it is advantageous to use a water-repellent or waterproof material as material, such as a flexible plastic material.

In the case of flip-flops, the problem often arises in practice that after a certain period of use, the toe bridge tears out of the sole. On the one hand, this makes the shoe unusable for further use. On the other hand, however, this also poses a considerable safety risk. In order to prevent the toe bridge from being pulled out, it is known to positively secure the toe bridge from being pulled out of the sole by means of a button. However, this button is usually located on the outsole of the shoe, which means that it is subject to increased wear.

In order to reduce this wear, it is known that the buttons of toe bridges are made of hard plastic. However, this has the disadvantage that hard plastic does not have a good coefficient of friction, which worsens the adhesion of the sole to the ground. This deterioration in friction is also locally limited, so that the coefficient of friction varies depending on the load on the shoe. This also poses a certain safety risk.

In general, it is common for flip-flops to have no tread, or at least almost no tread, on the outsole. This poses an increased safety risk, especially on wet, slippery floors.

The object of the invention is to create a shoe, in particular in the form of a bathing sandal, whose safety when worn is improved. At the same time, the wearing comfort can also be improved. Furthermore, the shoe should be designed in such a way that it can be offered at market-compatible prices and with a market-compatible appearance.

The object of the invention is solved in particular by the features of the independent claim.

In order to increase safety, the shoe according to the invention is provided in particular with a strap, a toe bridge, a tread on the outsole and a relatively large button for securing the toe bridge, the button preferably being designed in such a way that it does not interfere with the tread and yet provides a good form fit. Optionally, a non-slip, comfortable insole may be provided, which additionally also improves the rolling motion when walking. A heel strap may also contribute to increased safety.

The invention relates to a shoe, in particular a bathing sandal, comprising a sole with an outsole, a tread arranged in the form of a tread pattern on the outsole, a strap which, together with the sole, forms a foot opening for holding the foot in the metatarsal and/or toe area, and a toe bridge, wherein the toe bridge extends from the strap through the foot opening and through a toe bridge opening of the sole and is positively secured on the underside of the sole by a button against being pulled out of the toe bridge opening.

According to the invention, it is provided that the button has a shape that completes the tread pattern.

Optionally, it is provided that the tread is composed of individual, recurring tread elements which form a relief-like structure, and that the button has the shape of a tread element and thus forms a tread element of the tread.

Optionally, it is provided that a recess for holding the button is provided in the outsole respectively the shoe bottom, wherein the outline of the recess corresponds to the outline of the button.

Optionally, it is provided that a heel strap is provided for holding the heel.

Optionally, it is provided that the tread of the outsole extends onto the strap and/or the heel strap and thereby increases the roughness and/or the stiffness in this region, the tread being continued in particular with an unchanged tread pattern on the strap and/or the heel strap.

Optionally, it is provided that the tread pattern comprises a plurality of different recurring geometric shapes, such as circles, rectangles, parallelograms, semi-circles, arcs, stars or the like, and that the button has the shape of one of these recurring shapes.

Optionally, it is provided that the sole comprises a base body and an inner sole, and that the inner sole comprises at least one insole made of a conformable, non-slip material, such as closed-cell foam in particular.

Optionally, it is provided that the sole has a ball region for contact with the ball of the foot, that the sole has a heel region for contact with the heel, and that the sole has a mid region arranged between the ball region and the heel region, the mid region having a smaller bending stiffness than the ball region and the heel region.

Optionally, it is provided that the insole, for reducing the bending stiffness in the mid region, is omitted, and in particular that one insole is provided in the ball region and a further insole is provided in the heel region.

Optionally, it is provided that the strap, the outsole and the tread are formed by an integral body of flexible plastic or rubber.

In embodiments, the shoe and in particular said integral body may be made of any suitable material, such as suitable rubber, PVC, vinyl and/or EVA. In particular, the material of the integral body is a material which is suitable for use as sole and in particular as tread. The button of the toe bridge is preferably made of the same material as the integral body.

Preferably, it is provided that the strap and the sole are an integral body, which is preferably produced by injection molding. Preferably, the tread is also part of this integral body. The insole may be a retrofitted part. The toe bridge may also be retrofitted.

In embodiments, the strap may be a straight strap or may comprise at least one straight section, such as is known from conventional slippers.

The outsole has a tread, which is arranged in the form of a tread pattern. Optionally, the tread pattern comprises recurring tread elements. Preferably, the button for positively securing the toe bridge in the sole is adapted such that it completes the tread of the sole. This forms an outsole with a safe, continuous, optionally uniform, tread. In this, the button may be made comparatively large without compromising the effect of the outsole's tread. If the button is made of the same or similar material as the outsole respectively its tread, safety may be further increased.

The button may be held in a recess in the sole, with the outline of the recess corresponding to the outline of the button, so that the button is held laterally. In any case, this may increase safety.

In any case, the button can be designed and arranged in such a way that it does not negatively affect the physical properties of the outsole, such as the coefficient of friction and the uniformity of the tread.

In the following, the invention is described with reference to the following figures.

### BRIEF DESCRIPTION OF THE DRAWINGS

FIG. 1 shows a schematic view of a sectional view of a possible embodiment of a shoe.

FIG. 2 shows a schematic view of one embodiment of the shoe.

FIG. 3 shows a side view of a possible embodiment of a shoe.

FIGS. 4a, 4b and 4c show different possible embodiments of the tread.

### DETAILED DESCRIPTION OF THE PREFERRED EMBODIMENTS

Unless otherwise stated, the reference signs correspond to the following components:

Sole 1, outsole 2, tread 3, strap 4, foot opening 5, toe bridge 6, toe bridge opening 7, button 8, tread element 9, recess (for holding the button) 10, heel strap 11, base body 12, inner sole 13, insole 14, ball region 15, heel region 16, mid region 17.

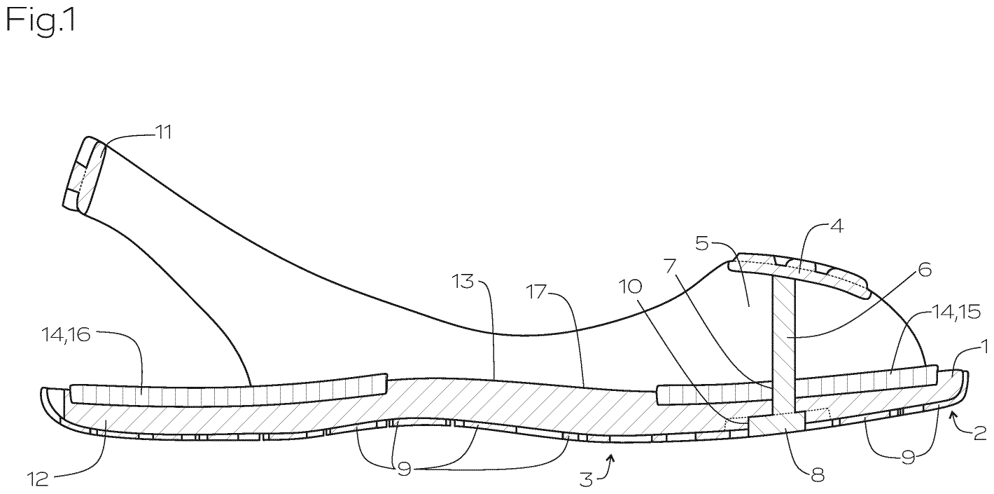

FIG. 1 shows a schematic view of a sectional view of a possible embodiment of a shoe according to the invention. In particular, the shoe is formed as a bathing sandal. It comprises a sole 1 and a strap 4. The strap 4 is arranged above the sole 1 and forms a foot opening 5 into which a foot can be inserted so that it is held in the metatarsal or toe area.

The shoe comprises a toe bridge 6 which extends through the foot opening 5 to pass between two toes, as is known for example in flip-flops. The toe bridge 6 extends from the strap 4 to the sole 1. In particular, the toe bridge 6 extends through a toe bridge opening 7 of the sole 1. A button 8 is provided to fix the toe bridge 6 to the sole 1. This button 8 should be larger in size than the toe bridge opening 7, thereby preventing the toe bridge 6 from being pulled out of the toe bridge opening 7. Preferably, the toe bridge 6 is also connected to the strap 4, wherein this connection may be made, for example, in a materially bonded manner by means of an adhesive connection or welded connection.

In the present embodiment, a recess 10 is provided in the sole 1. This recess 10 serves to hold respectively receive the button 8.

In this embodiment, the shoe comprises a heel strap 11 adapted and/or configured to be arranged above the heel of the user.

In the present embodiment, the sole 1 comprises a base body 12 having an inner sole 13 that is in contact with the user's foot when worn. The inner sole 13 may comprise respectively be partially formed from at least one insole 14. In the present embodiment, two insoles 14 are provided, one in the ball region 15 and one in the heel region 16. For example, the insoles 14 may be formed of a material that increases the comfort and also the safety of the shoe. For example, the insoles 14 may be formed of a foam material respectively a closed-cell foam material.

In the present embodiment, the mid region 17 is kept free, i.e., no insole 14 is arranged in this region. For example, the material of the insole 14 is selected such that it increases the bending stiffness of the sole 1 as a stiffening element. By omitting the insole 14 in the mid region 17, the sole 1 can have a lower bending stiffness in this region, which may increase the wearing comfort but also the safety of the shoe.

The outsole 2 of the sole 1 comprises a tread 3. This tread 3 comprises multiple tread elements 9. Preferably, it is provided that the button 8 completes the tread 3. In particular, the button 8 has the shape and/or properties of a tread element 9.

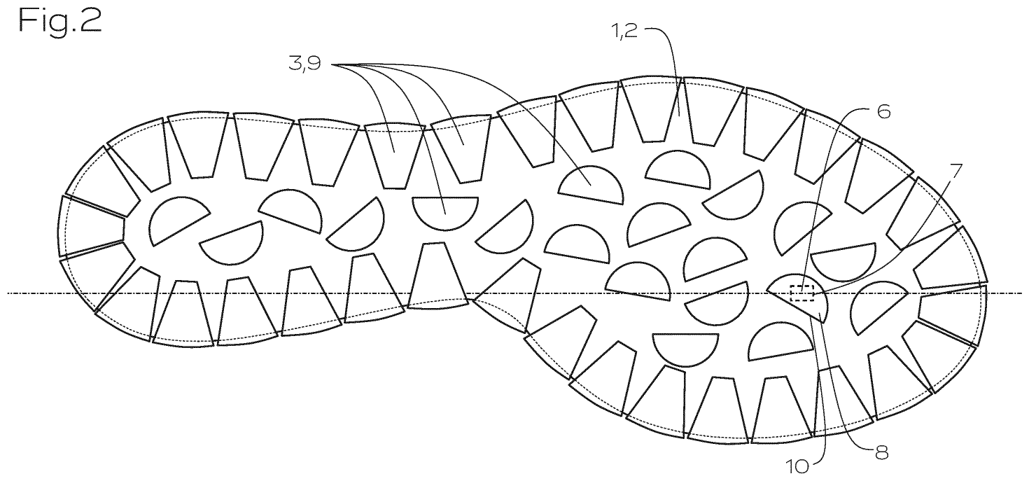

FIG. 2 shows a schematic view of an embodiment of the shoe, in particular of the embodiment of FIG. 1. In FIG. 2, a section line is shown, which is the section line for the sectional view of FIG. 1, for example.

FIG. 2 shows in particular a plan view of the outsole 2 of the sole 1. It has a tread 3 with multiple tread elements 9. The tread elements 9 and the tread 3 follow a certain tread pattern. The latter preferably comprises multiple recurring tread elements 9. The tread elements 9 serve primarily the technical purpose of increasing the friction relative to different grounds, but their shape may be varied within the scope of technical possibilities. In the present embodiment, they have wedge-shaped respectively semi-circular outlines.

The shoe comprises a button 8 for positively holding the toe bridge 6 on the sole 1. In this embodiment, the button 8 has the outline respectively the shape of a tread element 9. Preferably, the button 8 is made of a material which has substantially the same properties as the tread elements 9.

In the sole 1, a recess 10 is provided, into which a button 8 may be at least partially inserted. In particular, the recess 10 is designed such that the button 8 is also held laterally. Preferably, the recess 10 has an outline, which corresponds to the outline of the button 8. In the present embodiment, the recess 10 is semi-circularly shaped.

Preferably, the button 8 has a greater extension than the toe bridge opening 7, so that the toe bridge 6 is positively prevented from being pulled out of the sole 1.

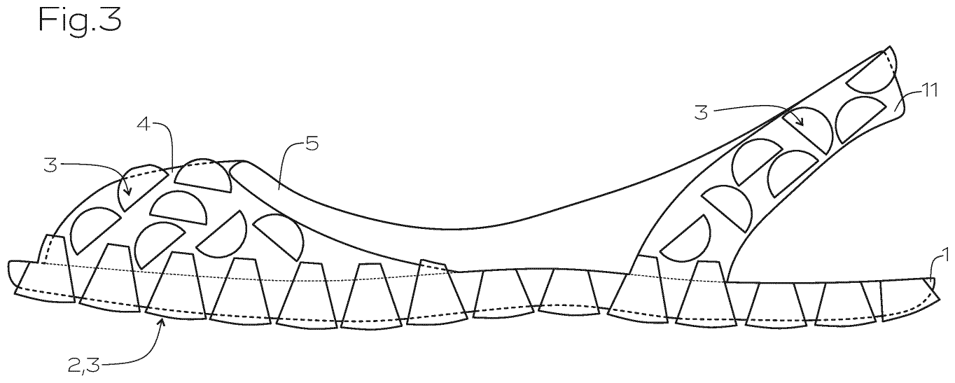

FIG. 3 shows a side view of a possible embodiment of a shoe, wherein the embodiment preferably corresponds to the embodiment of the FIGS. 1 and/or 2. The shoe comprises a sole 1 with an outsole 2 and a tread 3. Further, the shoe comprises a strap 4, which, together with the sole 1, forms or defines a foot opening 5 for receiving a foot. In the present embodiment, the tread 3 extends at least partially onto the strap 4 as well. In particular, multiple tread elements 9 are provided on the strap 4, which are also found in this shape on the outsole 2. By arranging a tread 3 on the strap 4, the coefficient of friction in this region may be increased and the strap 4 may optionally be reinforced.

In the present embodiment, a heel strap 11 is also provided on the shoe. The tread 3 may also be provided on this heel strap 11.

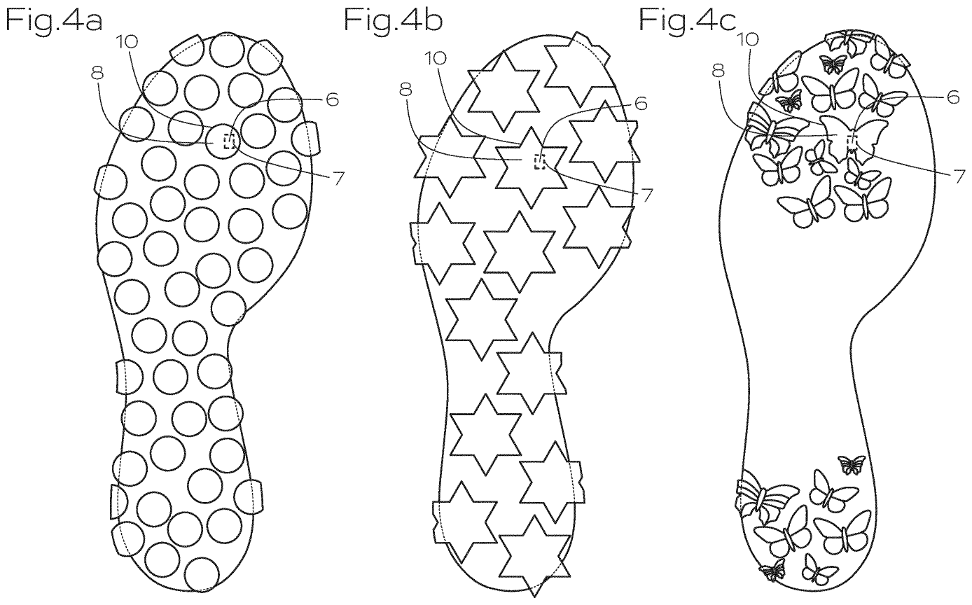

FIGS. 4a, 4b and 4c show different possible embodiments of the tread 3 that may be arranged on the outsole 2 of the sole 1. In particular, the embodiments of FIGS. 1 to 3 may alternatively be provided with one of these treads 3.

In FIG. 4a, the tread elements 9 of the tread 3 are circular in shape, and the button 8 is also circular in shape. In FIG. 4b, the tread elements 9 are star-shaped, and in FIG. 4c, the tread elements 9 have the exemplary shape of butterflies.

In all embodiments, it is preferably provided that the button 8 has a shape completing the tread pattern. In this way, the technical advantages according to the invention can be achieved.

The button 8 has a shape that completes the tread pattern. In particular, this forms a uniform tread 3. Preferably, the button 8 has a shape corresponding to the shape of a recurring tread element 9. However, optionally, the sizes of the individual tread elements 9 and thereby also of the button 8 may be varied with respect to the tread elements 9. The proportions may be maintained or slightly modified.

1. A shoe, comprising:
a sole with an outsole and a toe bridge opening,
a tread arranged in the form of a tread pattern on the outsole,
a strap which, together with the sole, forms a foot opening for holding the foot in the metatarsal and/or toe area,
a toe bridge, wherein the toe bridge extends from the strap through the foot opening and through the toe bridge opening of the sole, and
a button configured to secure the toe bridge to the sole by preventing the toe bridge from being pulled out of the toe bridge opening, wherein the button has a shape that completes the tread pattern.

2. The shoe according to claim 1, wherein the tread is composed of individual, recurring tread elements which form a relief-like structure, and wherein the button has the shape of a tread element and thus forms a tread element of the tread.

3. The shoe according to claim 1, further comprising a recess for holding the button provided in the outsole, wherein the outline of the recess corresponds to the outline of the button.

4. The shoe according to claim 1, further comprising a heel strap for holding the heel of the foot.

5. The shoe according to claim 1, wherein the tread of the outsole extends onto the strap and thereby increases the roughness and/or the stiffness in this region, the tread being continued in particular with an unchanged tread pattern on the strap.

6. The shoe according to claim 1, wherein the tread pattern comprises a plurality of different recurring geometric shapes, and the button has the shape of one of these recurring shapes.

7. The shoe according to claim 1, wherein the sole further comprises a base body and an inner sole, wherein the inner sole comprises at least one insole made of a conformable, non-slip material.

8. The shoe according to claim 7, wherein:
the sole has a ball region for contact with the ball of the foot,
the sole has a heel region for contact with the heel of the foot, and
the sole has a mid region arranged between the ball region and the heel region, the mid region having a smaller bending stiffness than the ball region and the heel region.

9. The shoe according to claim 8, wherein:
the insole is omitted in the mid region for reducing the bending stiffness in the mid region, and
the insole is provided in the ball region and a further insert is provided in the heel region.

10. The shoe according to claim 1, wherein the strap, the outsole and the tread are formed by an integral body of flexible plastic or rubber.

11. The shoe according to claim 1, wherein the button is made of the same material as the tread.

12. The shoe according to claim 1, wherein the toe bridge is made of the same material as the tread.

13. The shoe according to claim 6, wherein the plurality of different recurring geometric shapes are selected from the group including circles, rectangles, parallelograms, semi-circles, arcs, stars, or the like.

14. The shoe according to claim 1, comprising a bathing sandal.
